(19) United States
(12) Patent Application Publication
(10) Pub. No.: US 2004/0239866 A1
(43) Pub. Date: Dec. 2, 2004

(54) Liquid crystal display device

(75) Inventors: Takashi Sasabayashi, Kawasaki (JP); Norio Sugiura, Kawasaki (JP)

Correspondence Address: Patrick G. Burns, Esq., GREER, BURNS & CRAIN, LTD., Suite 2500, 300 South Wacker Drive, Chicago, IL, 60606, US

(73) Assignee: FUJITSU DISPLAY TECHNOLOGIES CORPORATION.

(21) Appl. No.: 10/806,057

(22) Filed: Mar. 22, 2004

(30) Foreign Application Priority Data
Mar. 28, 2003 (JP) 2003-091357(PAT.)

(51) Int. Cl. C09K 19/02; G02F 1/1337

(52) U.S. Cl. 349/178

(57) ABSTRACT

A liquid crystal display device of an MVA type and excellent in the visual angle characteristics has been disclosed. In the liquid crystal display device comprising two substrates and a liquid crystal layer, a structure provide so as to partition the liquid crystal layer and for forming at least one enclosed domain within each pixel is comprised, the alignment of the liquid crystal molecules while a voltage is being applied is symmetric with respect to a plane parallel to the substrate and almost passing through the center in the direction of the thickness of the liquid crystal layer, and an oblique ray of incident light passes through two domains the alignment orientations of which are different from each other.

### BACKGROUND OF THE INVENTION

The present invention relates to a liquid crystal display device. More particularly, the present invention relates to a technique to improve the visual angle characteristics of a liquid crystal display device in which liquid crystal molecules are aligned almost vertically, with respect to the substrate surface, while no voltage is being applied.

In recent years, the liquid crystal display device has come into wide use in various applications because of its features such as thinness, compactness, low-voltage driving and low-power consumption.

Currently, however, the display characteristics when a liquid crystal panel is viewed in an oblique direction, that is, the visual angle characteristics are inferior to those of a CRT. Therefore, a liquid crystal panel excellent in visual angle characteristics is demanded.

As a liquid crystal panel excellent in visual angle characteristics, a liquid crystal panel of a multi-domain vertically aligned (MVA) type has been put to practical use and Japanese Unexamined Patent Publication (Kokai) No. 11-242225 has disclosed its configuration.

The principles of the improvement in the visual angle characteristics of the liquid crystal panel of an MVA type are explained with reference to FIG. 1. FIG. 1A to FIG. 1C show the motion of the liquid crystal in the liquid crystal panel of a vertically aligned (VA) type and FIG. 1D to FIG. 1F show the motion of the liquid crystal in the liquid crystal panel of an MVA type. In a panel of a VA type, vertically aligned films are formed on transparent electrodes 12 and 13 provided on the substrate surfaces opposed to each other, and a nematic liquid crystal layer whose dielectric constant anisotropy is negative is obtained. As shown in FIG. 1A, while no voltage is being applied (during the period when no voltage being applied), liquid crystal molecules 10 are aligned almost vertically with respect to the substrate and a black display is obtained. When an intermediate voltage is applied, the liquid crystal molecules 10 are tilted and a halftone (gray level) display is obtained as shown in FIG. 1B. When a higher voltage is applied, the liquid crystal molecules 10 are aligned horizontally and a white display is obtained as shown in FIG. 1C. During the halftone display, as shown in FIG. 1B, the tilt of the liquid crystal molecule differs depending on the direction of incident light, resulting in the difference in the brightness of the display depending on the viewing direction. In other words, the visual angle characteristics are degraded.

In the liquid crystal panel of an MVA type, therefore, domain control means for controlling the orientation of tilting of the liquid crystal molecules during the period with a voltage being applied are provided on the surfaces of the electrodes 12 and 13 and vertically aligned films are formed thereon as shown in FIGS. 1D to 1F. In FIG. 1D to FIG. 1F, a slit 21 is formed in the electrode 12, as a domain control means, and dielectric protrusions 20 are provided on the electrode 13 as a domain control means. As shown in FIG. 1E, when an intermediate voltage is applied, domains in which the directions of the tilted liquid crystal molecules are different from each other are formed because of the slit 21 and the protrusions 20. Therefore, an oblique ray of incident light is bound to pass through a domain in which the tilt of liquid crystal is large with respect to the light and a domain in which the tilt is small, and as a result, the actual brightness becomes the same as that of a vertical ray of incident light because of averaging. By the way, as shown in FIG. 1D and FIG. 1F, the situations in a panel of an MVA type while no voltage is being applied and while a high voltage is being applied are the same as that in a panel of a VA type.

FIG. 2 is a diagram showing an example of the pixel layout disclosed in Japanese Unexamined Patent Publication (Kokai) No. 11-242225, wherein only the electrodes and the protrusions are shown, when the substrate is viewed in the vertical direction. In FIG. 2, reference number 13 denotes pixel electrodes provided on the TFT substrate. In the figure, the pixel electrode is divided into two parts, that is, an upper part and a lower part, by an auxiliary electrode 35 making up an auxiliary capacity, but the shape is a rectangle whose ratio of width to length is about 1:3. Between the pixel electrodes, a gate bus line 31 extends in the transverse direction and a data bus line 32 extends in the longitudinal direction, and a TFT 33 is provided in the vicinity of their crossing. There is provided a dielectric protrusion 20B extending zigzag on the pixel electrode 13, the gate bus line 31 and the data bus line 32. On the other hand, there is provided a dielectric protrusion 20A extending zigzag and arranged between the protrusions 20B so as to oppose the protrusion 20B on the opposing substrate (CF substrate). In other words, the zigzag protrusions 20A and 20B are formed alternately on the CF substrate and the TFT substrate so as to be opposed to each other.

FIG. 3A and FIG. 3B are diagrams showing the alignment of the liquid crystal molecules using the conventional protrusions for a panel of an MVA type. The parts denoted by reference symbols A and B in FIG. 2 correspond to the domain A and the domain B shown in FIG. 3A and FIG. 3B. At the parts denoted by reference symbols C and D in FIG. 2, the orientation of alignment of the liquid crystal molecules is different by 90 degrees from that of the domains A and B. Japanese Unexamined Patent Publication (Kokai) No. 11-242225 mentioned above provides a detailed explanation about the liquid crystal panel of an MVA type, therefore, no explanation will be given here.

As shown in FIG. 3A, during the period with no voltage being applied, the liquid crystal molecules 10 are aligned vertically with respect to the substrate surface. As aligned vertically with respect to the protrusion surface on the protrusion, the liquid crystal molecules are aligned on the slope of the protrusion in a tilted state with respect to the substrate surface. As shown in FIG. 3B, during the period with a voltage being applied, the orientation in which the liquid crystal molecules are tilted is controlled uniformly in the domain between the protrusions because of the influence of the liquid crystal molecules on the slope of the protrusion. In the case of FIG. 3A and FIG. 3B, the alignment with two domains A and B, in which the orientations of tilting of the liquid crystal molecules are opposite to each other, is realized. In the domains C and D, the alignment with two domains in which the orientations of tilting of the liquid crystal molecules are different by 90 degrees from those in the domains A and B, therefore, the alignment with four domains, in which the orientations of tilting of the liquid crystal molecules are those in the domains A, B, C and D, respectively, is realized in one pixel.

FIG. 4 is a diagram showing the tilting orientations of the liquid crystal molecules in the four domains A, B, C and D in the pixel layout in FIG. 2. The visual angle characteristics are shown in FIG. 5A to FIG. 5H when polarizing elements are arranged at both sides of the liquid crystal panel so that the axes of absorption are in the directions of 0 degree and 90 degrees in FIG. 4. FIG. 5A to FIG. 5H show the transmittance-voltage characteristics when the liquid crystal panel in the orientations of 0°, 45°, 90°, 135°, 180°, 225°, 270° and 315° is viewed from the front (0°) to an oblique direction (70°) in increments of 10°. The angle 0° means the direction perpendicular to the panel surface in each orientation and the characteristics are the same regardless of the orientation. As shown schematically, it is found that the black transmittance (during the period with no voltage being applied) becomes high, resulting in degradation in contrast when the liquid crystal panel in the orientations of 45°, 135°, 225° and 315° is viewed in an oblique direction.

It is possible to solve this problem by stacking phase difference films on the liquid crystal panel. If it is assumed that the indexes of refraction in the direction in the film plane of the phase difference film are nₓ, and n_{y}, and the index of refraction in the norm direction of the film is n_{z}, a phase difference film which satisfies any one of the relations nₓ>n_{y}>n_{z}, nₓ=n_{y}>n_{z} and nₓ>n_{y}=n_{z}, or a combination of them is used normally. The visual angle characteristics, when a phase difference film which satisfies nₓ=n_{y}>n_{z} is used in the liquid crystal panel of an MVA type with the pixel layout shown in FIG. 2, are shown in FIG. 6A to FIG. 6H. By the use of the phase difference film, the rise in the black transmittance is prevented in the orientations of 45°, 135°, 225° and 315°, which is shown in FIG. 5A to FIG. 5H.

As shown by the part surrounded by a dotted line in FIG. 6B and FIG. 6C, the phenomenon, in which the transmittance is higher when the liquid crystal panel is viewed obliquely than when viewed perpendicularly thereto when a voltage somewhat higher than the threshold voltage is applied, is observed in every orientation. This phenomenon cannot be corrected even if any one of the above-mentioned phase difference films is used. In the vicinity of the part to which a voltage somewhat higher than the threshold voltage is applied, the transmittance is low and, therefore, variations in transmittance depending on the viewing angle are very outstanding. In fact, when an image having low to halftone gradations is displayed, the display seems as if colored with white and brown when the liquid crystal panel is viewed obliquely. This phenomenon (referred to as white-browning hereinafter) is a major factor which degrades the display quality of the liquid crystal panel of an MVA type and must be corrected.

### SUMMARY OF THE INVENTION

The object of the present invention is to provide a liquid crystal display device excellent in visual angle characteristics by improving the visual angle characteristics of a liquid crystal panel of an MVA type.

In order to attain the above-mentioned object, according to the present invention, an oblique ray of incident light is made to pass through two domains having different alignment orientations of the liquid crystal molecules.

FIG. 7A and FIG. 7B are diagrams showing the relationship between the thickness of the liquid crystal layer and the size of the protrusion of the conventional liquid crystal panel of an MVA type and FIG. 7A is a sectional view and FIG. 7B is a top view. By referring to FIG. 7A and FIG. 7B, the cause of the white-browning phenomenon mentioned above is explained. AS shown in FIG. 7A and FIG. 7B, in the case of the conventional panel, the width of the protrusion or slit for controlling the alignment orientation is about 10 μm because the problems of manufacture and the stability of alignment are taken into account, and the arrangement pitch of the protrusion and slit is set large. By the way, the width of the liquid crystal layer (cell gap or cell thickness) is, for example, about 4 μm. As a result, the width of the domain or the width of the boundary domain between the domains A and B is significantly greater than the width of the liquid crystal layer (cell gap), and a ray of light obliquely passing through the liquid crystal panel is unlikely to pass through both domains A and B during the passage of the ray of light through the liquid crystal panel. Therefore, an oblique ray of light incident to the domain B as shown in FIG. 7A passes through the tilted liquid crystal molecules almost perpendicular and the transmittance is relatively high. As a matter of course, the transmittance of a ray of light parallel to the ray of light 1 passing through the domain A is low, but in a state of low-transmittance in which a voltage somewhat higher than the threshold voltage is being applied, such a slight rise in transmittance has a strong influence and the white-browning phenomenon results. This phenomenon can be prevented from taking place by making an oblique ray of incident light is made to pass through two domains.

FIG. 8A to FIG. 8C are diagrams for explaining the principle of the present invention. In order to make an oblique ray of incident light pass through two domains, there are three possible aspects: FIG. 8A shows a first aspect according to the present invention; FIG. 8B shows a second aspect according to the present invention; and FIG. 8C shows a third aspect according to the present invention.

In the first aspect, as shown in FIG. 8A, two different domains are formed in the longitudinal direction of a liquid crystal panel and an oblique ray of incident light 2 is made to pass through the two domains.

FIG. 9A to FIG. 9C and FIG. 10A to FIG. 10C are diagrams for explaining the difference in the motion of the liquid crystal molecules when a voltage is being applied between the conventional liquid crystal panel of an MVA type and that in the first aspect according to the present invention. In the conventional liquid crystal panel of an MVA type, as shown in FIG. 9A, the liquid crystal molecules 10 are aligned almost vertically across the liquid crystal layer (cell gap) during the period with no voltage being applied. In other words, the liquid crystal molecules 10 are vertical to the electrodes 12 and 13 on which vertically aligned films have been formed. When an intermediate voltage is applied, as shown in FIG. 9B, the liquid crystal molecules 10 are tilted and the tilting orientation is uniform along the direction of the thickness of the liquid crystal layer in each domain and domains with different tilting orientations exist within the panel plane. When a higher voltage is applied, the liquid crystal molecules 10 are further tilted to be almost horizontal, as shown in FIG. 9C, but the tilting orientations in FIG. 9B are maintained.

In contrast to this, in the first aspect according to the present invention, as shown in FIG. 10A, the liquid crystal molecules 10 are aligned almost vertically across the liquid crystal layer (cell gap) during the period with no voltage being applied as in the conventional case. When an intermediate voltage is applied, as shown in FIG. 10B, the liquid crystal molecules 10 on the upper side are tiled in a certain tilting orientation and the liquid crystal molecules 10 on the lower side are tilted in the opposite direction so that the tilting orientation is opposite to that on the upper side. At this time, the liquid crystal at the center with respect to the thickness of the liquid crystal layer is not tilted but remains vertical. When a higher voltage is applied, as shown in FIG. 10C, the liquid crystal molecules 10 are further tilted to be almost horizontal, but the tilting orientations in FIG. 10B are maintained. In other words, in the first aspect according to the present invention, the alignment of the liquid crystal molecules, during the period with a voltage applied, is characterized by being symmetric with respect to a plane parallel to the substrate and almost passing through the center in the direction of the thickness of the liquid crystal layer. In other words, two liquid crystal layers are formed in the vertical direction and the alignment orientation in one of the liquid crystal layers is opposite to the alignment orientation in the other.

FIG. 11 is a diagram showing the tilting orientations of the liquid crystal molecule when the panel is viewed from the vertical direction in the first aspect. The directions of 0° and 90° are the directions of the axes of absorption of the polarizing elements, and when the tilting orientations of the liquid crystal molecules are 45° and 225°, the liquid crystal molecules 10 tilted in one direction and those tilted in the opposite direction exist at the same place, as a result. Therefore, every vertical or oblique ray of incident light is bound to pass through the two domains, in which the liquid crystal molecules are tilted in the directions opposite to each other.

The visual angle characteristics of the liquid crystal panel in the first aspect according to the present invention are shown in FIG. 12A to FIG. 12H. FIG. 12A to FIG. 12H show the transmittance-voltage characteristics when the liquid crystal panel in the first aspect in the orientations of 0°, 45°, 90°, 135°, 180°, 225°, 270° and 315° is viewed from the front (0°) to an oblique direction (70°) in increments of 10°, corresponding to FIG. 5A to FIG. 5H, respectively. FIG. 13A to FIG. 13H show the transmittance-voltage characteristics when the liquid crystal panel to which the phase difference films have been applied in the first aspect in the orientations of 0°, 45°, 90°, 135°, 180°, 225°, 270° and 315° is viewed from the front (0°) to an oblique direction (70°) in increments of 10°, corresponding to FIG. 6A to FIG. 6H, respectively. AS is obvious from the comparison between FIG. 6A to FIG. 6H and FIG. 13A to FIG. 13H, in the panel in the first aspect, it is found that a rise in transmittance when the panel is viewed in an oblique direction is reduced, which occurs when a voltage somewhat higher than the threshold voltage is applied, as shown by the parts surrounded by the dotted line in FIG. 6B and FIG. 6C. In other words, the white-browning phenomenon can be prevented. Moreover, a rise in transmittance of black in the orientations of 45°, 135°, 225° and 315°can be reduced by the use of the phase difference film as in the case of the conventional liquid crystal panel of an MVA type.

The alignment of the liquid crystal as in the first aspect is realized by providing a dielectric structure on the electrodes sandwiching the liquid crystal layer or by bonding two liquid crystal panels having the same characteristics in such a way that the alignment is symmetric between the two panels.

In a second aspect according to the present invention, as shown in FIG. 8B, the domains A and B are made to be next to each other in the transverse direction as conventionally, but the widths of the domains A and B and the width of the boundary region therebetween are narrowed so that an oblique ray of incident light passes through both the domains A and B. As explained in FIG. 9A and FIG. 9B, in the conventional liquid crystal panel of an MVA type also, domains having different tilting directions of the liquid crystal are next to each other, but as the widths of the domains and the width of the boundary region are considerably wider compared to the cell gap, an oblique ray of incident light passes through only one of the domains and almost no ray passes through both domains. In the second aspect, contrary to this, as the widths of the domains and the width of the boundary region are narrow, an oblique ray of incident light passes through both domains. Even if only part of an oblique ray of incident light is made to pass through both domains, the white-browning phenomenon can be prevented to a certain extent. In other words, to what extent the white-browning phenomenon can be prevented depends on how much of an oblique ray of incident light actually passes through the two domains.

In a third aspect, the domains A and B are made to be next to each other as conventionally but the domains A and B are shifted from each other in the direction of thickness of the panel so that an oblique ray of incident light 4 passes through the two domains A and B, as shown in FIG. 8C. The domains A and B are shifted from each other in the direction of thickness of the panel by, for example, forming dielectric structures 70A and 70B on the electrodes 12 and 13 and shifting the position of the layer of each domain in the direction of thickness, as shown in FIG. 8C.

### BRIEF DESCRIPTION OF THE DRAWINGS

The features and advantages of the invention will be more clearly understood from the following description taken in conjunction with the accompanying drawings, wherein:

FIG. 1A to FIG. 1F are diagrams for explaining the principles of improvement in the visual angle characteristics of a liquid crystal panel of an MVA type.

FIG. 2 is a diagram showing a conventional example of protrusions for a liquid crystal panel of an MVA type formed on a substrate.

FIG. 3A and FIG. 3B are diagrams for explaining the alignment by the conventional protrusions for a liquid crystal panel of an MVA type.

FIG. 4 is a diagram showing a coordinate system for representing viewing angles and tilting orientations of the liquid crystal molecules in a liquid crystal panel of an MVA type.

FIG. 5A to FIG. 5H are diagrams showing the visual angle characteristics of a conventional liquid crystal display device of an MVA type.

FIG. 6A to FIG. 6H are diagrams showing the visual angle characteristics when phase difference films are used in the conventional liquid crystal display device of an MVA type.

FIG. 7A and FIG. 7B are diagrams showing the relationship between the thickness of a liquid crystal layer and the size of a protrusion in the conventional liquid crystal panel of an MVA type.

FIG. 8A to FIG. 8C are diagrams for explaining the principles of the present invention.

FIG. 9A to FIG. 9C are diagrams showing the tilting motion of the liquid crystal molecules in a conventional panel of an MVA type.

FIG. 10A to FIG. 10C are diagrams showing the tilting motion of the liquid crystal molecules in the first aspect according to the present invention.

FIG. 11 is a diagram showing the tilting orientations of the liquid crystal molecules in the first aspect.

FIG. 12A to FIG. 12H are diagrams showing the visual angle characteristics in the first aspect.

FIG. 13A to FIG. 13H are diagrams showing the visual angle characteristics when the phase difference films are used in the first aspect.

FIG. 14A and FIG. 14B are diagrams showing the panel structure in a first embodiment of the present invention.

FIG. 15A and FIG. 15B are diagrams showing the motion of the liquid crystal molecules in the first embodiment.

FIG. 16A and FIG. 16B are diagrams showing the alignment of the liquid crystal molecules while a voltage is being applied in the first embodiment.

FIG. 17A to FIG. 17C are diagrams showing the motion of the liquid crystal molecules in the first embodiment.

FIG. 18 is a diagram showing the tilting orientations of the liquid crystal molecules while a voltage is being applied in the first embodiment.

FIG. 19A to FIG. 19H are diagrams showing the visual angle characteristics in the first embodiment.

FIG. 20 is a diagram showing the panel structure in a second embodiment of the present invention.

FIG. 21A and FIG. 21B are diagrams showing the protrusion shape in a third embodiment of the present invention.

FIG. 22 is a diagram showing the distribution of domains in the third embodiment.

FIG. 23 is a diagram showing the panel structure in a fourth embodiment of the present invention.

FIG. 24A and FIG. 24B are diagrams showing modification examples of the panel structure in the fourth embodiment.

FIG. 25 is a diagram showing a modification example of the panel structure in the fourth embodiment.

FIG. 26 is a diagram showing an example of a planar shape of the panel structure in the fourth embodiment.

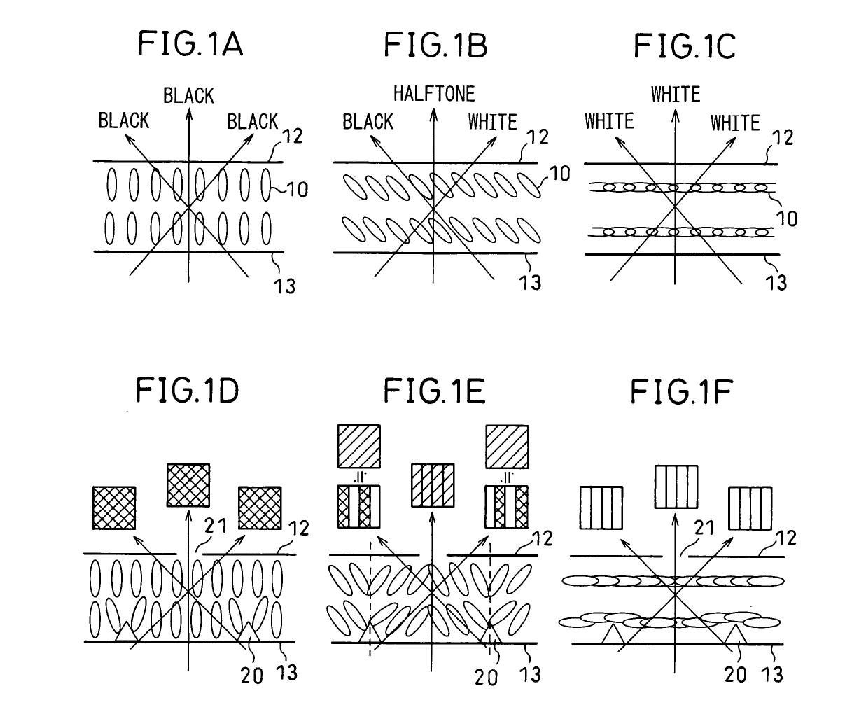

### DESCRIPTION OF THE PREFERRED EMBODIMENTS

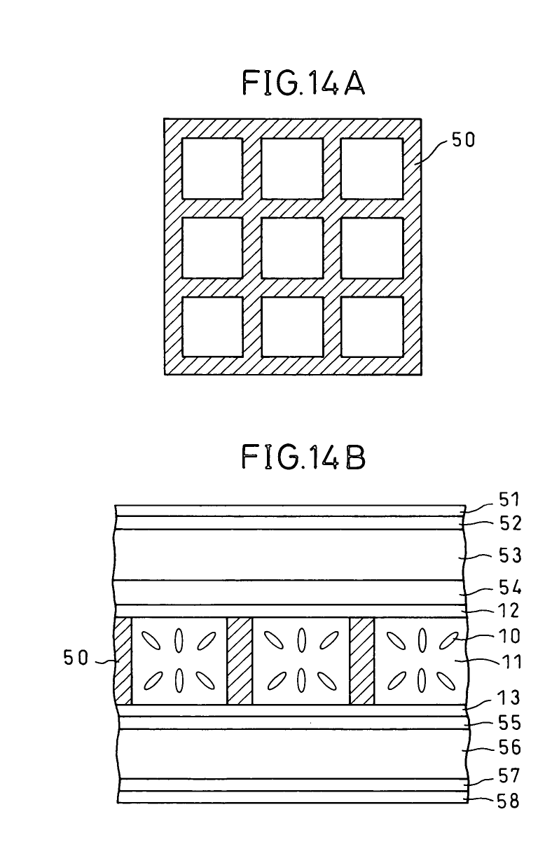

FIG. 14A and FIG. 14B are diagrams showing the panel structure of the liquid crystal display device of an MVA type in the first embodiment of the present invention: FIG. 14A is a plan view of a structure to be provided in a liquid crystal layer; and FIG. 14B is a section view of the panel.

As shown in FIG. 14B, the panel is formed by bonding glass substrates 53 and 56 together. The surface of the glass substrate is a display surface. A phase difference film 51 is provided on one surface of the glass substrate 53 and a polarizing element (polarizing film) 51 is provided thereon. A color filter 54 and the transparent common electrode 12 are formed on the other surface of the glass substrate 53. A phase difference film 57 is provided on one surface of the glass substrate 56 and a polarizing element (polarizing film) 58 is provided thereon. There may be a case where only one of the phase difference films 52 and 57 is provided. A layer 55 having a bus line, TFT, etc., and the transparent pixel electrode 13 are formed on the other surface of the glass substrate 56. Although vertically aligned films are formed on the electrodes 12 and 13, they are not shown schematically here. The polarizing elements 51 and 58 are arranged so that the axes of absorption are orthogonal to each other. The indexes of refraction of the phase difference films 52 and 57 satisfy one of the relations nₓ>n_{y}>n_{z}, nₓ=n_{y}>n_{z} and nₓ>n_{y}=n_{z} (nₓ and n_{y} are indexes of refraction in the film plane, n_{z} is an index of refraction in a direction perpendicular to the film).

A grid-shaped structure 50 as shown in FIG. 14A is arranged between the electrodes 12 and 13. This structure is made up of resist or the like and has a thickness equal to the thickness of the liquid crystal layer (cell gap) (for example, 4 μm), and it is desirable that the length of a side of each square domain enclosed by the grids is less than about three times that of the cell gap. After the structure 50 is arranged on one substrate and nematic liquid crystal whose dielectric constant anisotropy is negative is injected by the method of dropping injection or the like, the other substrate is bonded thereto.

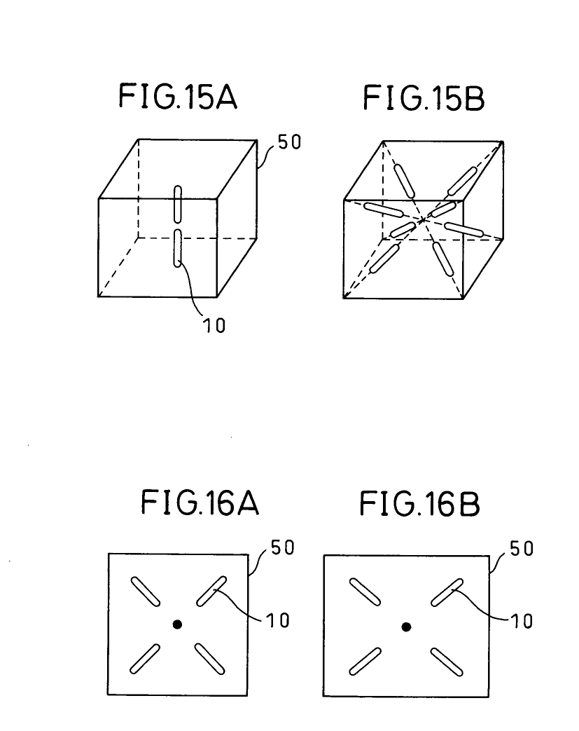

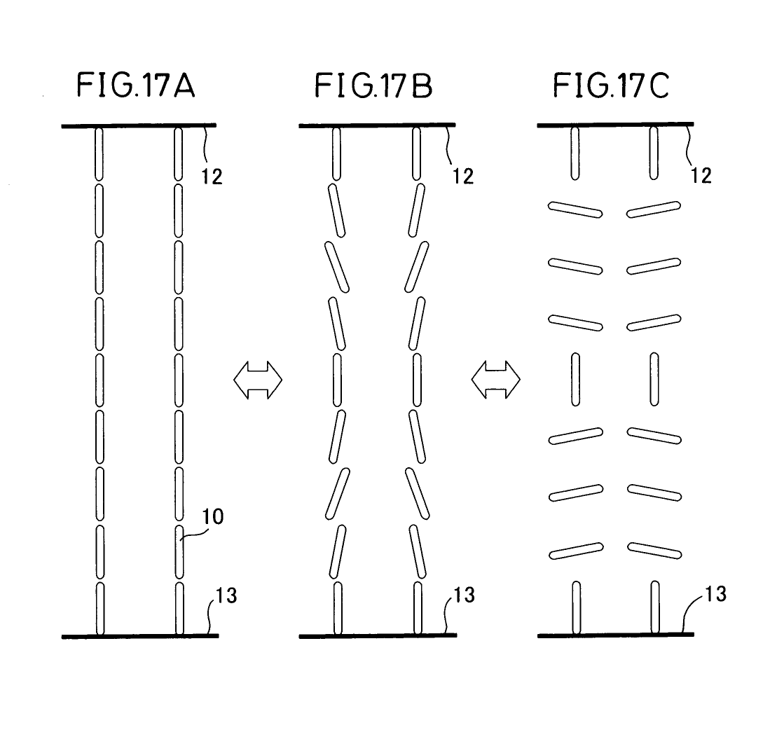

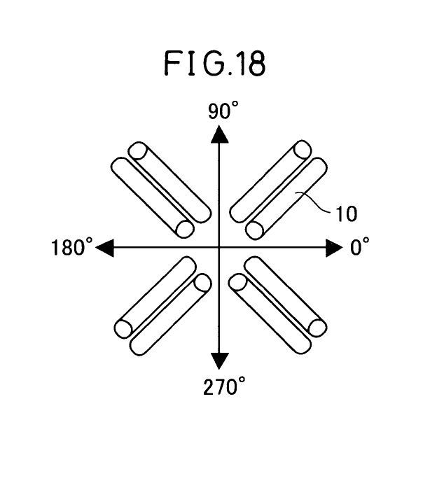

FIG. 15A and FIG. 15B show the alignment of liquid crystal molecules 10 inside the domain partitioned by the structure 50: FIG. 15A shows the alignment while no voltage is being applied; and FIG. 15B shows the alignment while a voltage is being applied. FIG. 16A is a plan view of the alignment while a voltage is being applied in each domain partitioned by the structure 50 and FIG. 16B is a sectional view of the alignment while a voltage is being applied in each domain partitioned by the structure 50. While no voltage is being applied, the liquid crystal molecules 10 are vertically aligned with respect to the electrodes 12 and 13 and while a voltage is being applied, the liquid crystal molecules 10 are aligned so that there exists at least one plane, which passes through the center of the domain, which is perpendicular to the panel surface (electrode), and with respect to which the liquid crystal molecules 10 are symmetric, and at the same time, so that the liquid crystal molecules 10 are symmetric with respect to a plane which almost passes through the center of the cell gap and is parallel to the substrate surfaces.

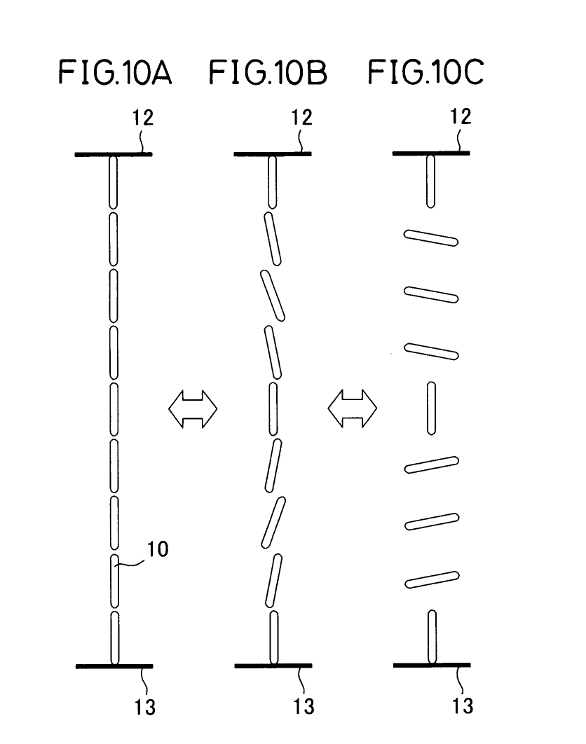

FIG. 17A to FIG. 17C are diagrams showing the motion of the liquid crystal molecules in the first embodiment. As is obvious from a comparison with FIG. 10A to FIG. 10C, multiple tilting orientations of liquid crystal molecules are produced at the upper and lower sides in the liquid crystal layer, respectively, and, while no voltage is being applied between the electrodes 12 and 13 (during the period with no voltage being applied), the liquid crystal molecules 10 are aligned vertically between the electrodes 12 and 13 as shown in FIG. 17A, and, while an intermediate voltage is being applied, the liquid crystal molecules 10 are tilted so that there exist two tilting orientations at the upper and lower sides, respectively, as shown in FIG. 17B, and, while a higher voltage is applied, the liquid crystal molecules are tilted almost horizontally as shown in FIG. 17C, but the tilting orientations in FIG. 17B are maintained.

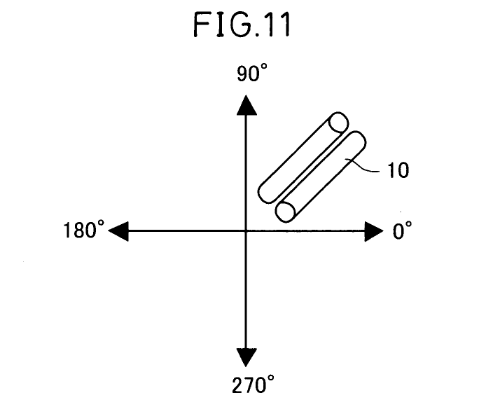

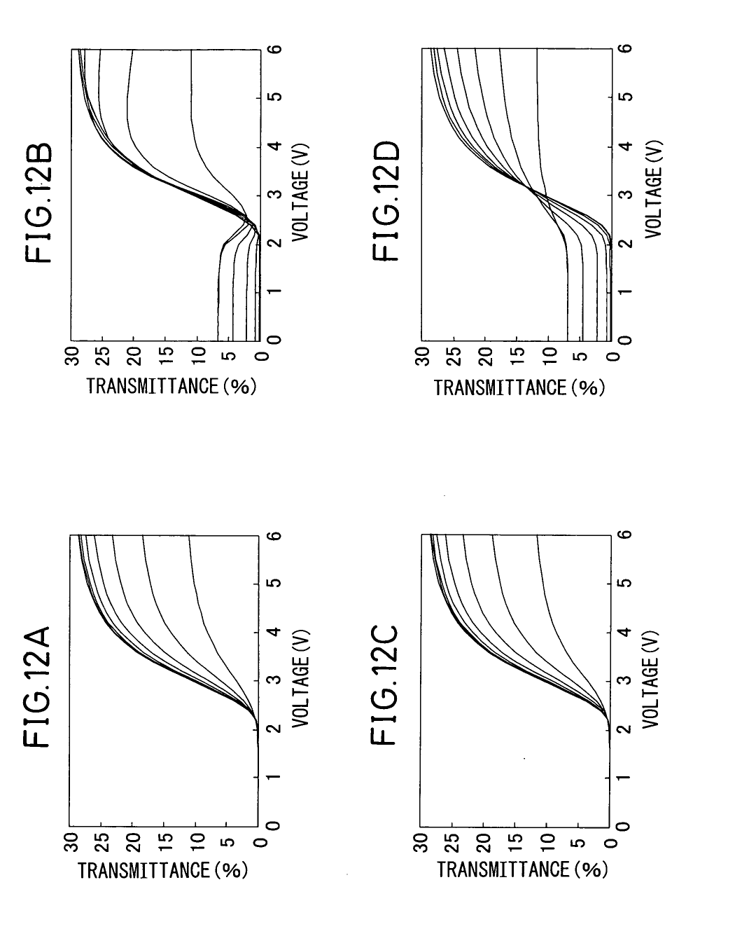

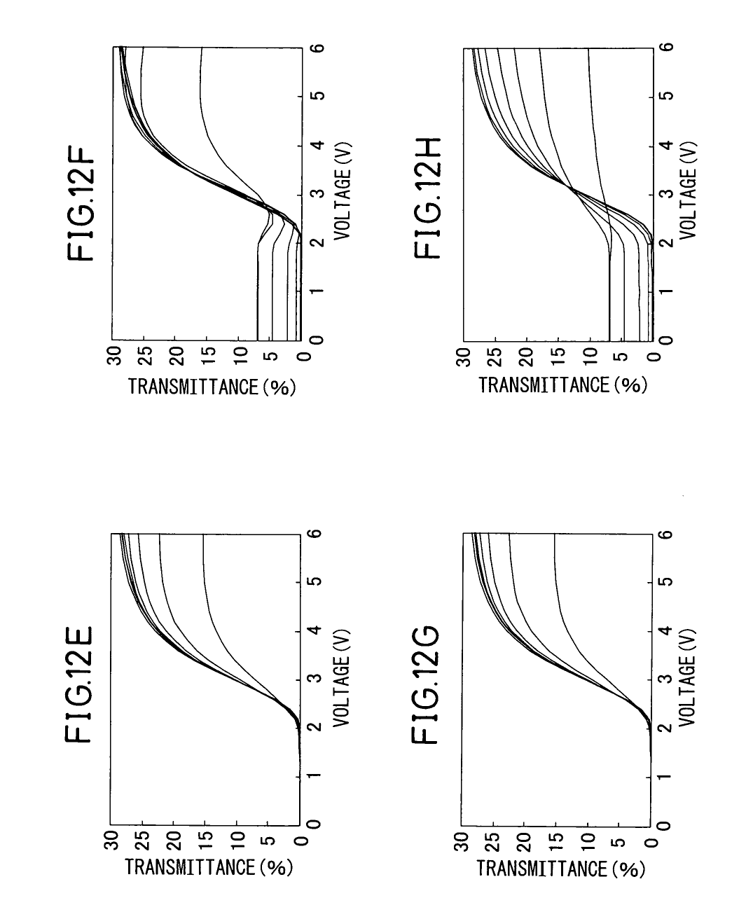

FIG. 18 is a diagram showing the tilting orientations of the liquid crystal molecules when the liquid crystal panel in the first embodiment is viewed in the vertical direction. In this case also, the directions of 0° and 90° are those of the axes of absorption of the polarizing elements. The liquid crystal molecules are tilted in the tilting orientations of 45°, 135°, 225° and 315° in each domain and the tilting directions at the upper side are opposite to those at the lower side. Due to this, the visual angle characteristics are further improved compared to the case of FIG. 10A to FIG. 10C and FIG. 11.

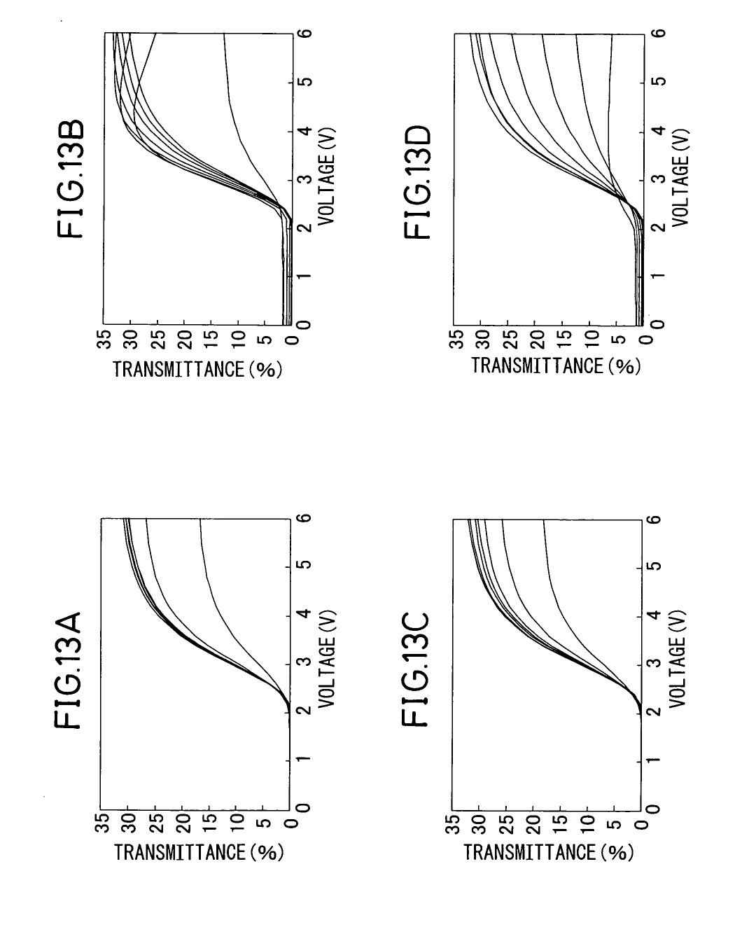

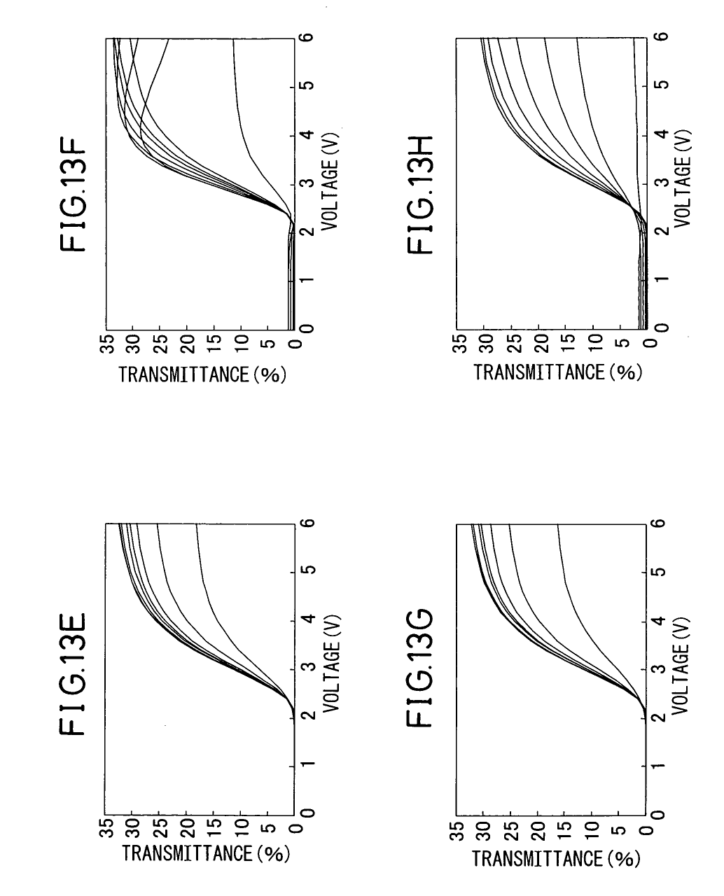

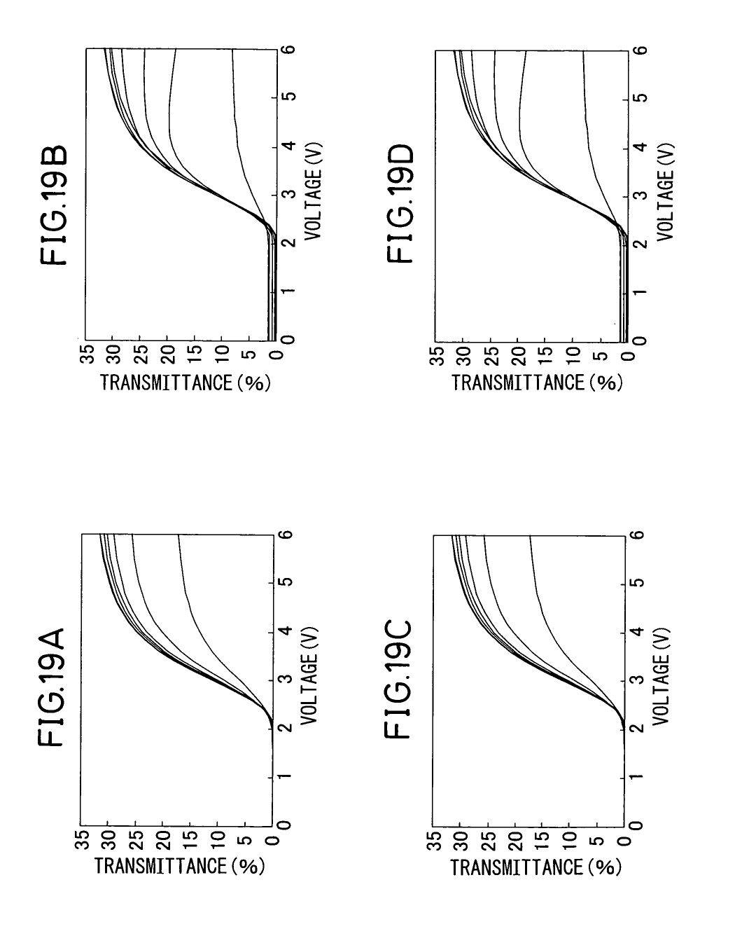

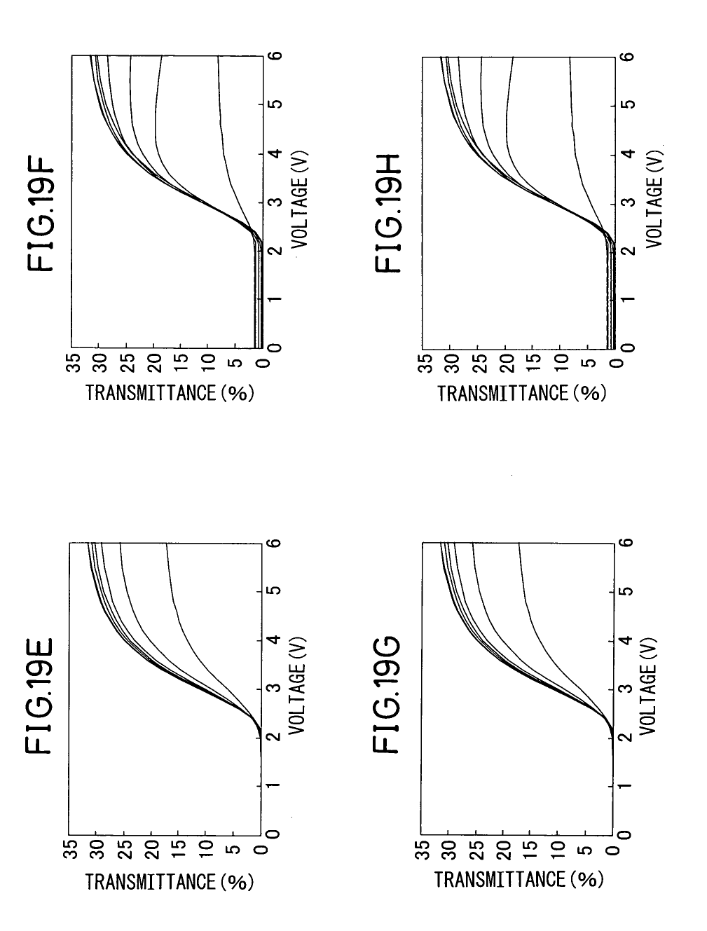

The visual angle characteristics of the liquid crystal display device in the first embodiment are shown in FIG. 19A to FIG. 19H. FIG. 19A to FIG. 19H show the transmittance-voltage characteristics when the panel of the liquid crystal display device in the first embodiment in the orientations of 0°, 45°, 90°, 135°, 180°, 225°, 270° and 315° is viewed from the front (0°) to an oblique direction (70°) in increments of 10°, corresponding to the FIG. 13A to FIG. 13H. As is obvious from a comparison with FIG. 13A to FIG. 13H, the visual angle characteristics of the panel in the first embodiment are further improved and the white-browning phenomenon can be prevented to a certain extent.

In the first embodiment, the shape of each domain in the structure is a cuboid whose top surface and bottom surface are square, but a cylindrical shape is also possible.

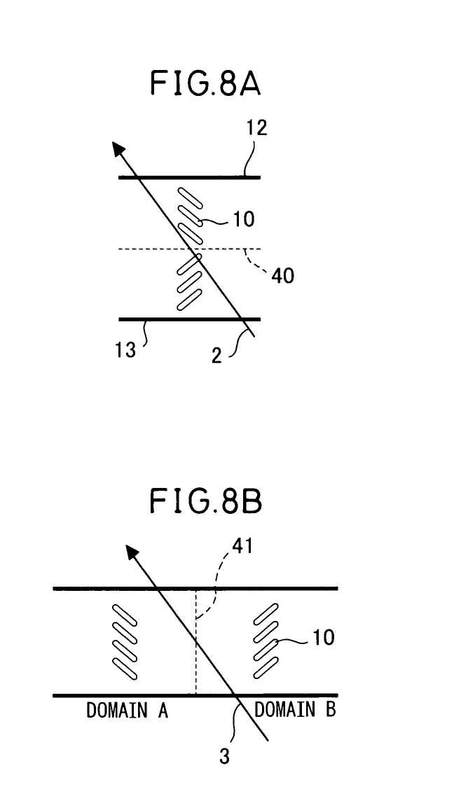

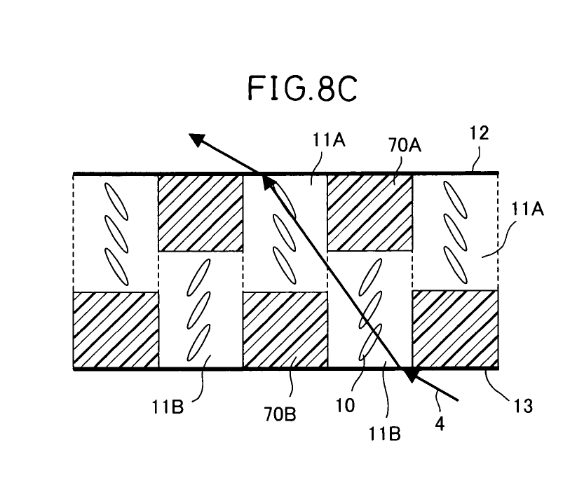

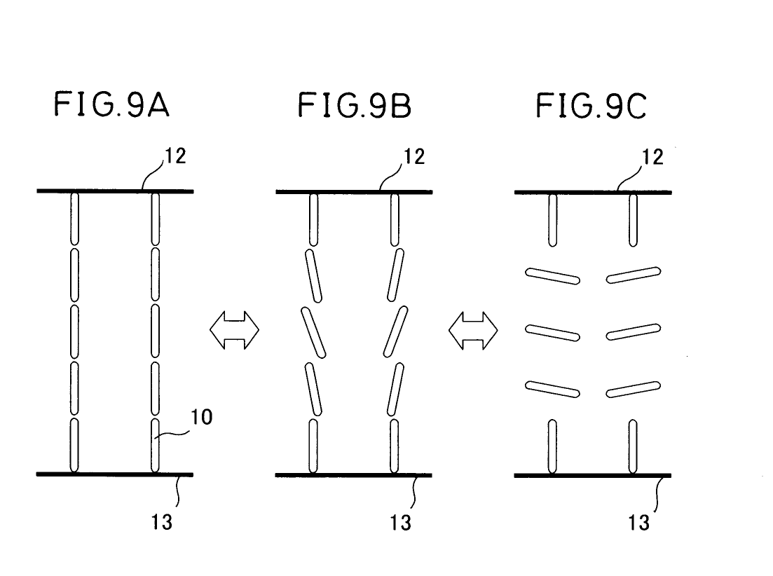

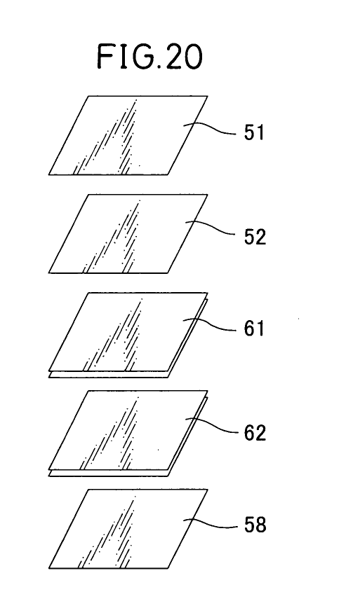

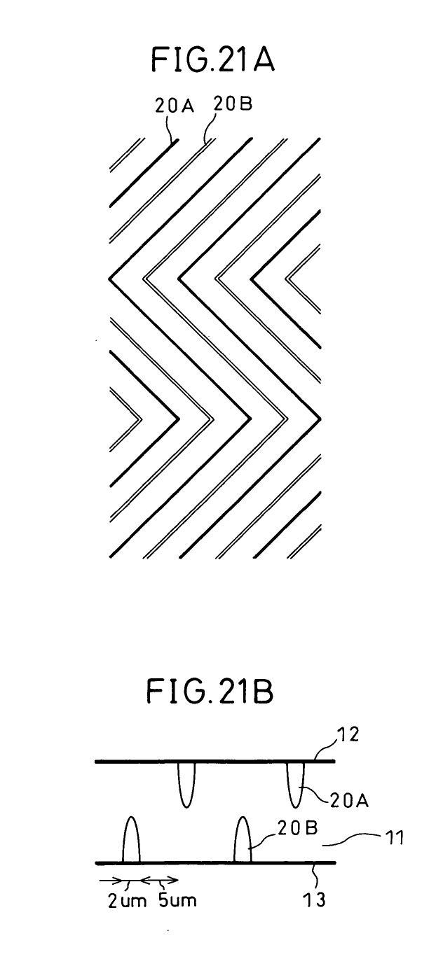

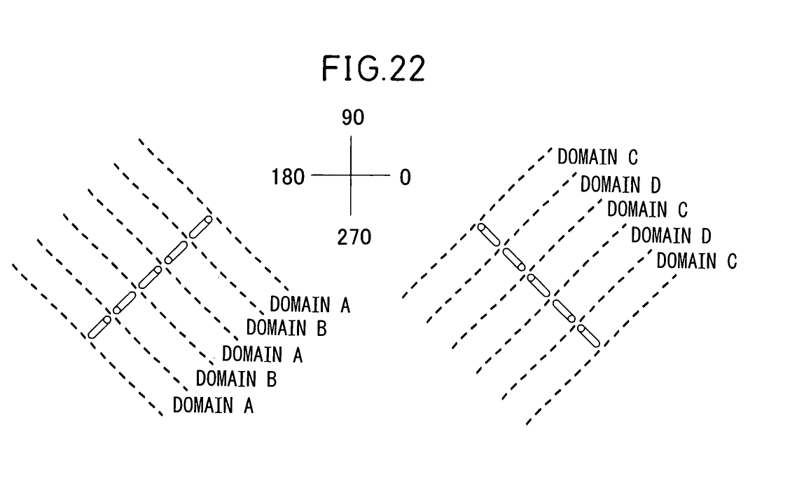

FIG. 20 is a diagram showing the structure of the liquid crystal display device in the second embodiment of the present invention. As shown schematically, the liquid crystal display device in the second embodiment is made up of two liquid crystal panels 61 and 62 bonded together, wherein the phase difference film 52 and the polarizing element 51 are provided on one side and the polarizing element 58 is provided on the other. The phase difference film 52 is the same as that in the first embodiment. The liquid crystal panel 61 and 62 are liquid crystal panels of a VA type and when a voltage is applied across the liquid crystal layer, the liquid crystal molecules are tilted in predetermined directions, respectively. In the liquid crystal panel 61, the liquid crystal molecules 10 are tilted from the state shown in FIG. 10A to the state shown at the upper side in FIG. 10C, and, in the liquid crystal panel 62, the liquid crystal molecules 10 are tilted from the state shown in FIG. 10A to the state shown at the lower side in FIG. 10C. By bonding two such panels together, the alignment is realized while a voltage is being applied, in which the liquid crystal molecules are symmetric with respect to a plane parallel to the substrate and almost passing through the center in the direction of the thickness of the liquid crystal layer, as shown in FIG. 8A and FIG. 10A to FIG. 10C.

When the liquid crystal panels 61 and 62 are liquid crystal display panels of an MVA type in which the liquid crystal molecules are aligned in multiple different tilting orientations as shown in FIG. 9A to FIG. 9C, the two panels 61 and 62 are bonded together in such a way that the domains thereof are aligned and the tilted state of the liquid crystal are symmetric between the upper and lower panels. In this case, the same visual angle characteristics as those shown in FIG. 19A to FIG. 19H can be obtained.

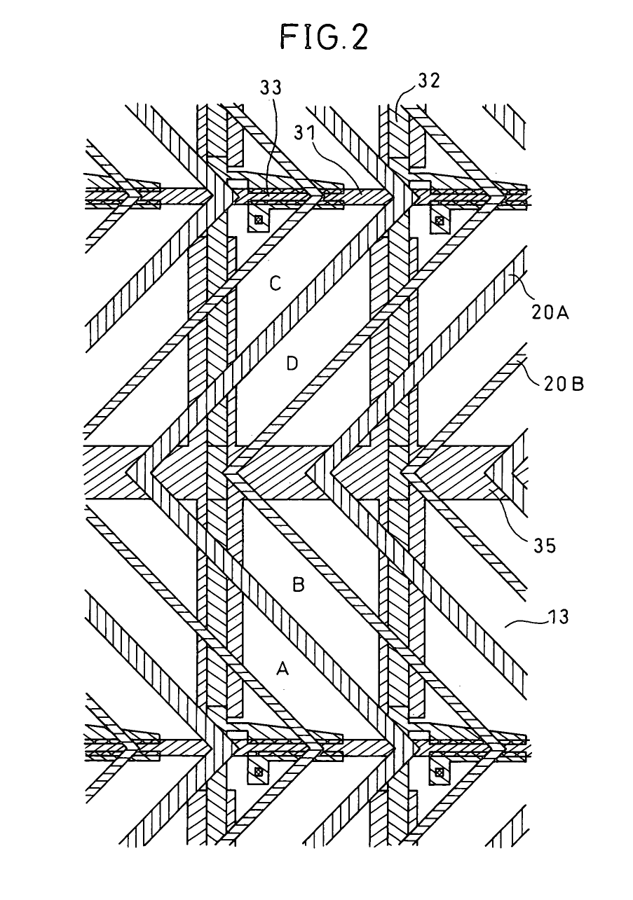

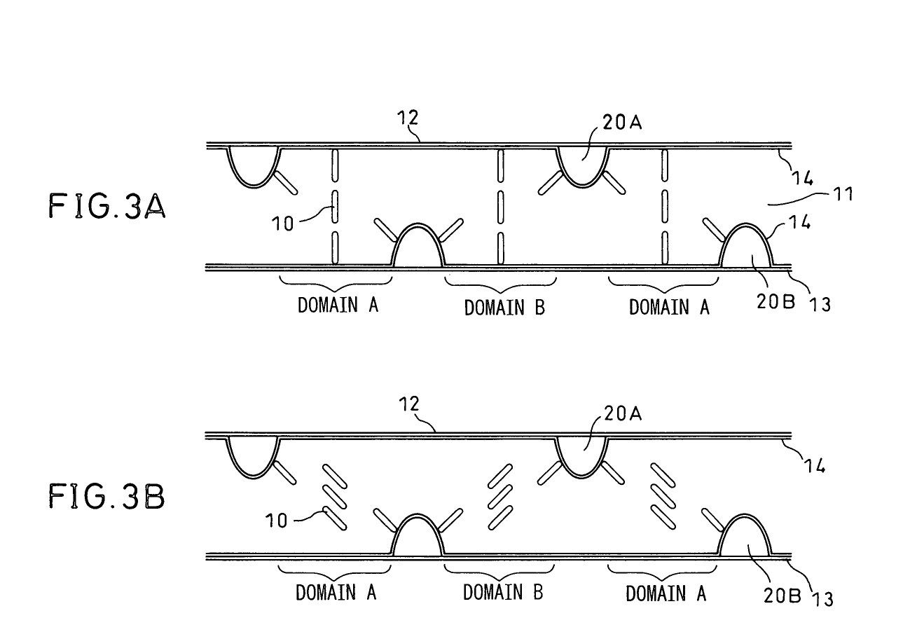

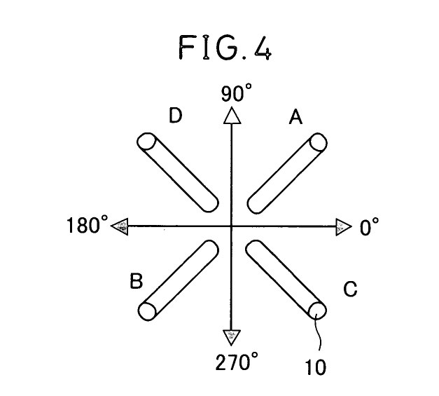

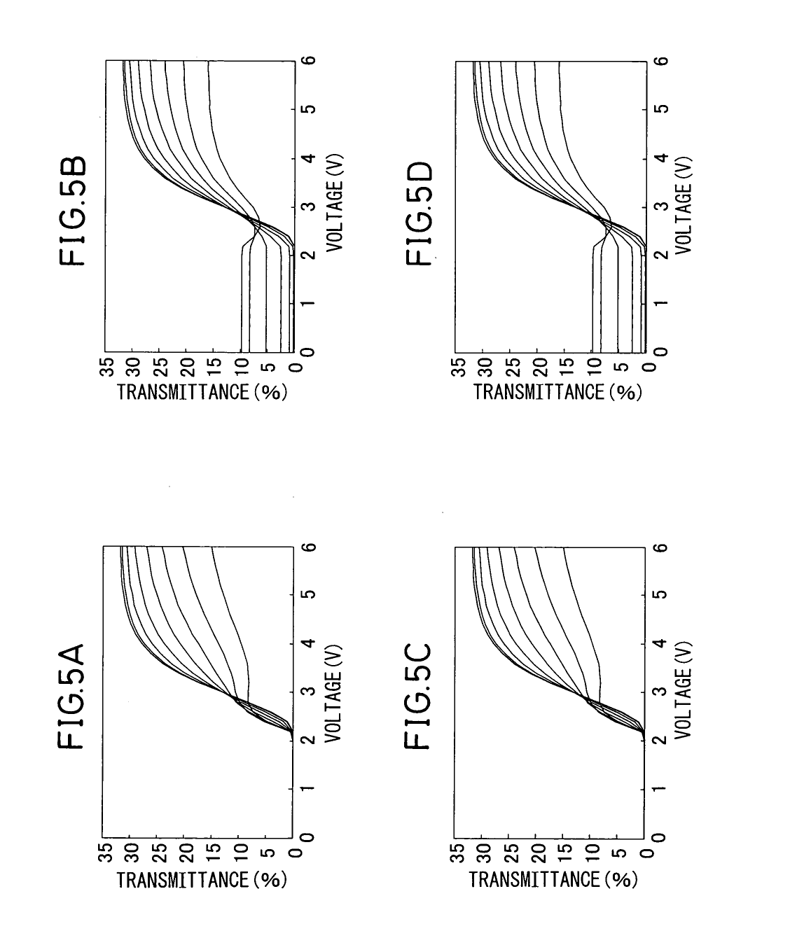

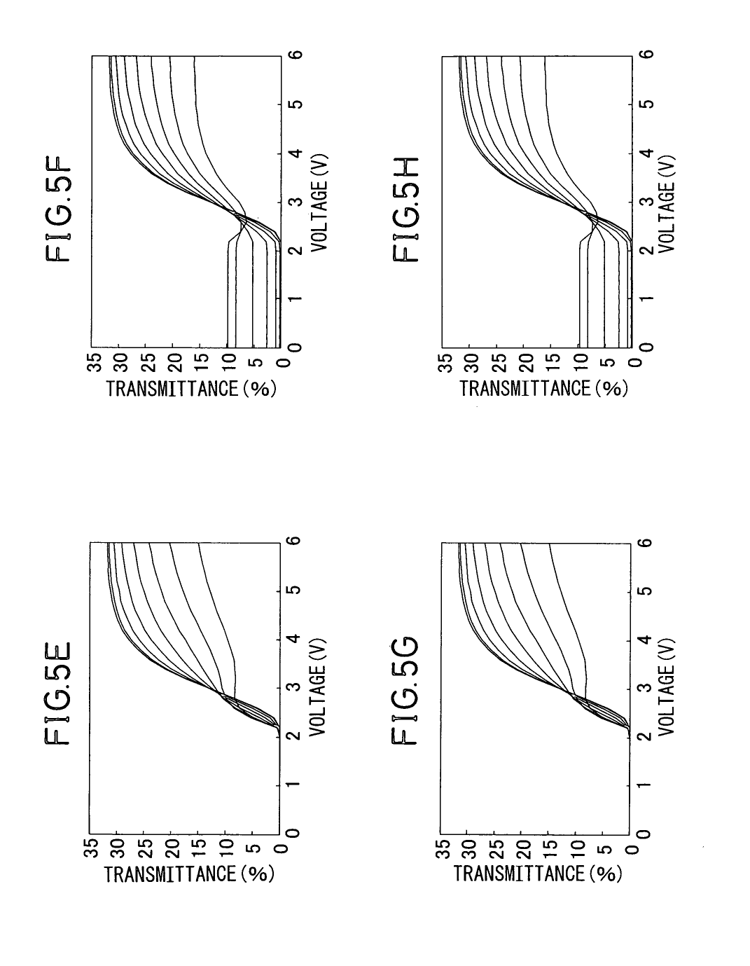

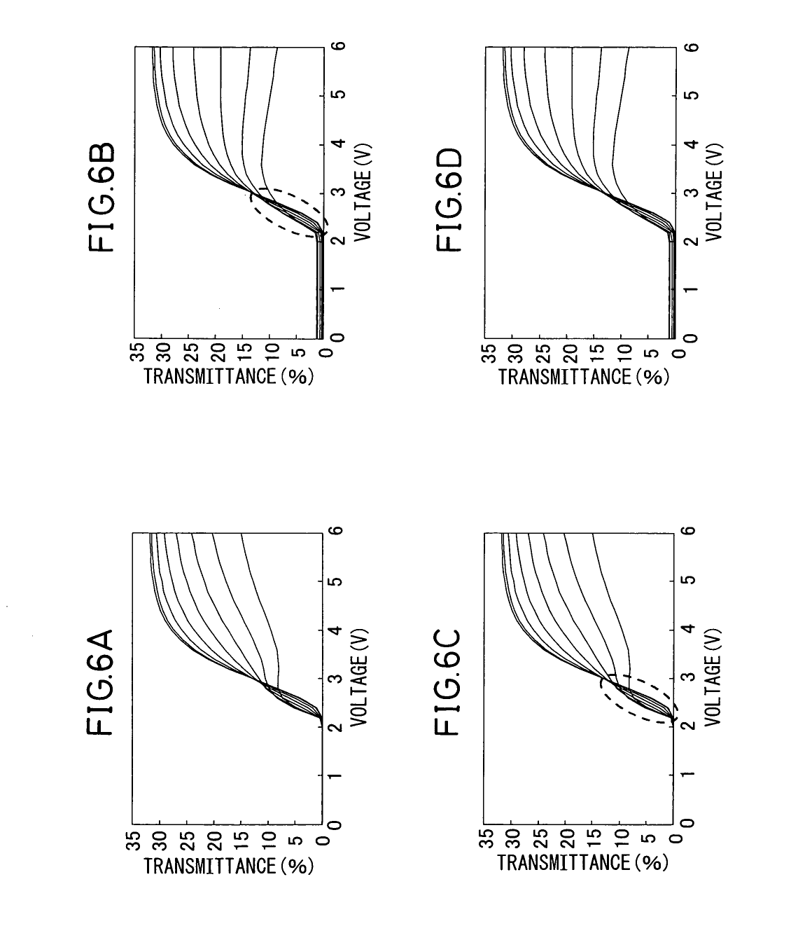

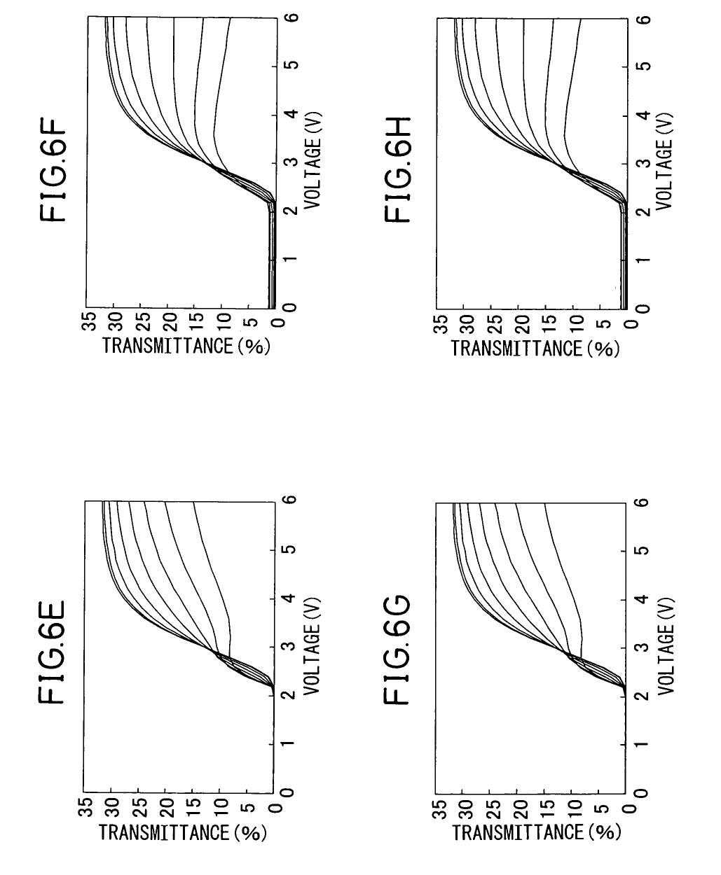

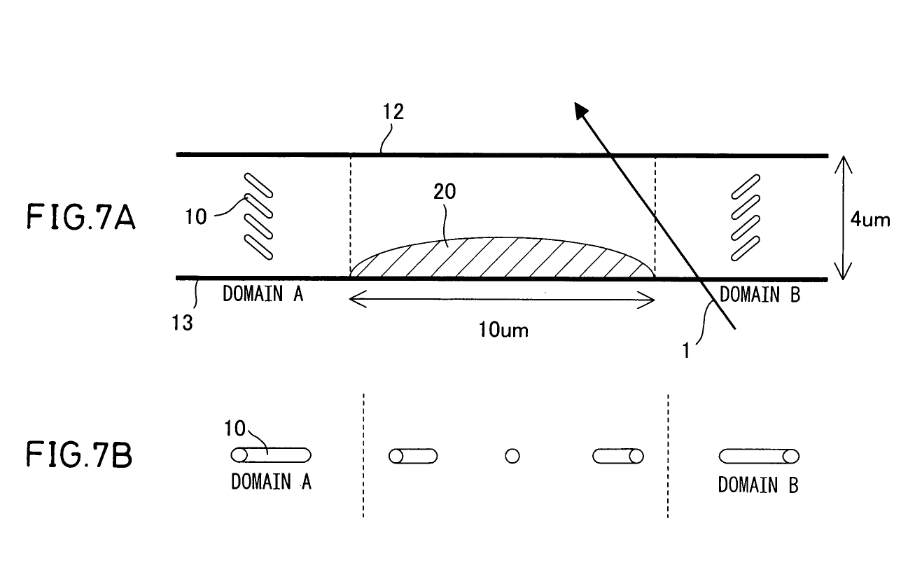

The liquid crystal display device in the third embodiment of the present invention has almost the same structure as that of the conventional liquid crystal display device of an MVA type and for example, the panel has zigzag dielectric protrusions as shown in FIG. 2 on the electrodes sandwiching the liquid crystal layer. Moreover, as in the first embodiment, the polarizing element and the phase difference film are provided, the vertically aligned films are formed on the surfaces of the opposing electrodes and nematic liquid crystal whose dielectric constant anisotropy is negative is inserted in between.

FIG. 21A and FIG. 21B are diagrams showing the shape of the zigzag dielectric protrusion of the liquid crystal display device in the third embodiment of the present invention and for example, while the cell gap has a thickness of 4 μm, the protrusion has a width of 2 μm and the distance between opposing protrusions is 5 μm, which are considerably smaller than those of the conventional ones.

As the protrusion is a zigzag, a domain consisting of the domains A (tilting orientation: 45°) and the domains B (tilting orientation: 225°), between which the difference in the tilting orientations of the liquid crystal molecules is almost 180°, and another domain consisting of the domains C (tilting orientation: 135°) and the domains D (tilting orientation: 315°), between which the difference in the tilting orientations of the liquid crystal molecules is almost 180° and the tilting orientations of which are different from those of the domains A and B by 90°, respectively, are formed, therefore, the visual angle characteristics are excellent.

The liquid crystal display device in the third embodiment is such one obtained by realizing the second aspect of the present invention and the width of the protrusion corresponds to the boundary domain between two neighboring domains and the distance between opposing protrusions corresponds to the width of the domain. To obtain a sufficient effect of the improvement of visual angle characteristics, it is desirable that the width of the protrusion (that is, the width of the boundary domain) is equal to or less than the thickness of the cell gap and the distance between opposing protrusions (that is, the width of the domain) is equal to or less than ten times the thickness of the cell gap.

In order to form domains whose tilting orientations are different from each another, a domain control means such as protrusion, dip or slit provided in the electrode, or a combination thereof can be used as in the conventional liquid crystal panel of an MVA type.

Moreover, the structure in the third embodiment, in which the width of the domain and the width of the boundary domain between neighboring domains are narrowed, is also effective when horizontally aligned films are used or liquid crystal whose dielectric constant anisotropy is positive is used.

In the third embodiment, the domains A and B are arranged next to each other in the transverse direction as conventionally, but the widths of the domains A and B and the width of the boundary domain are narrowed so that the oblique ray of incident light 3 is made to pass through the two domains A and B. Even if part of an oblique ray of incident light is made to pass through the two domains, the white-browning phenomenon can be prevented to a certain extent. In other words, to what extent the white-browning phenomenon can be prevented depends on how many percent of an oblique ray of incident light actually passes through the two domains.

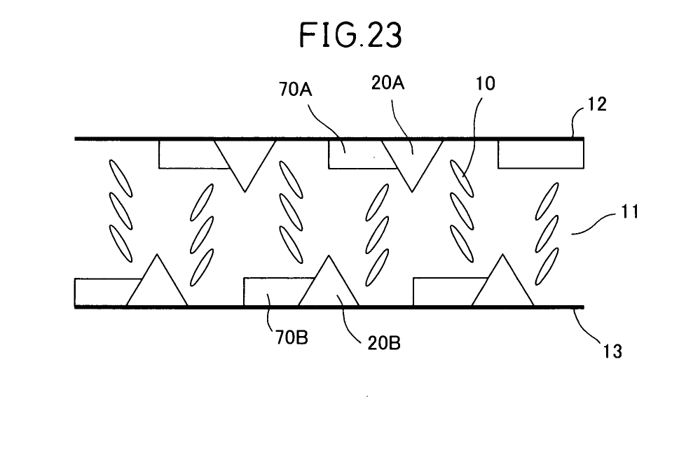

The liquid crystal display device in the fourth embodiment of the present invention is one obtained by realizing the third aspect of the present invention and FIG. 23 is a diagram showing the panel structure of the liquid crystal display apparatus in the fourth embodiment. The liquid crystal display device in the fourth embodiment of the present invention has almost the same structure as that of the conventional liquid crystal display device of an MVA type and that in the third embodiment, and the only difference lies in that the panel has such a structure as shown in FIG. 23. Therefore, the polarizing element and the phase difference film are provided as in the first embodiment, although not shown schematically, and the vertically aligned films are formed on the surfaces of the opposing electrodes and nematic liquid crystal whose dielectric constant anisotropy is negative is inserted in between. The cell gap is 4 μm and two glass substrates are bonded together via a spacer having a diameter of 4 μm. Moreover, the zigzag protrusions as shown in FIG. 2 are provided on the electrodes sandwiching the liquid crystal layer. A domain control means such as dip or slit provided in the electrode, instead of protrusion, or a combination thereof can be used.

In the fourth embodiment, as shown in FIG. 23, steps 70A and 70B made of transparent dielectric such as transparent resin are formed next to the protrusions 20A and 20B on the same side on the electrodes 12 and 13, and the vertically aligned films are formed thereon. Due to this, two domains, between which the difference in the tilting orientations of the liquid crystal molecules is 180°, are formed with the protrusions 20A and 20B being the boundary and, as a result, the liquid crystal layers in the two domains are deviated in the direction vertical to the substrate. The structure as shown in FIG. 8C is thus realized.

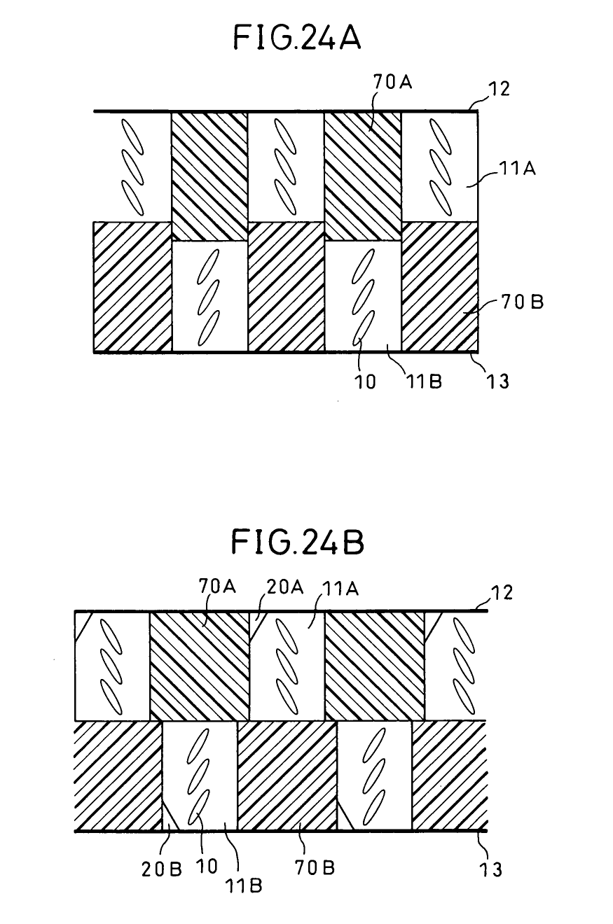

FIG. 24A is a diagram showing an example of modification of the steps 70A and 70B, wherein the steps 70A and 70B are made to be next to each other in a state in which the thickness of the steps 70A and 70B is increased so that the liquid crystal layer is separated into 11A and 11B. In FIG. 24B, the thickness of the steps 70A and 70B is adjusted to be half the distance between the electrodes 12 and 13 and the width of the steps 70A and 70B is increased so that the edge portions thereof are overlapped. Due to this, the steps 70A and 70B can be used as columnar spacers for controlling the cell gap.

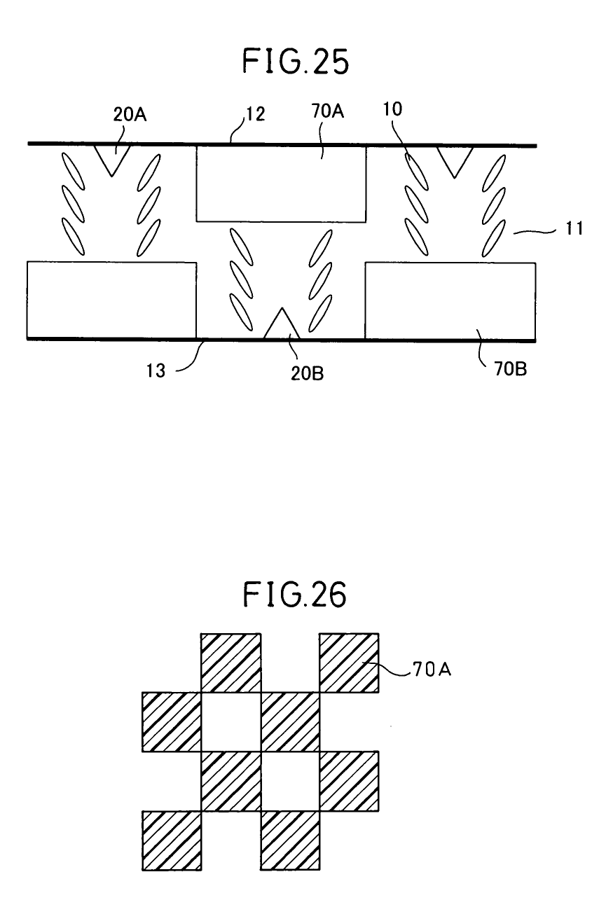

FIG. 25 is a diagram showing an example of a modification in which the steps 70A and 70B are provided so that the two domains on both sides of the protrusions 20A and 20B are shifted together in the vertical direction (direction perpendicular to the substrate). From this, the same effect can also be obtained.

In the fourth embodiment, the protrusions 20A and 20B have a zigzag shape as shown in FIG. 2 and the steps 70A and 70B are provided along the protrusions, but it may be possible to change the protrusions 20A and 20B into point-shaped ones and arrange the steps 70A and 70B in a checkerboard pattern as shown in FIG. 26.

Moreover, it is preferable for the steps 70A and 70B to be formed using resin having a high optical transmittance, but it is also possible to realize the step as part of the color filter (CF) shown in FIG. 14B.

As described above, according to the present invention, it is protect to protect the display screen from white-browning even when the liquid crystal display device of an MVA type is viewed in an oblique direction and thus the display quality can be further improved.

We claim:

1. A liquid crystal display device comprising: two substrates; a liquid crystal layer into which liquid crystal is inserted between opposing surfaces of the two substrates; and a structure provided so as to partition the liquid crystal layer and forming at least one enclosed domain in each display pixel, wherein the alignment of the liquid crystal molecules while a voltage is being applied is symmetric with respect to a plane parallel to the substrates and almost passing through the center in the direction of the thickness of the liquid crystal layer.

2. A liquid crystal display device, as set forth in claim 1, wherein the liquid crystal molecules have negative dielectric constant anisotropy and are almost vertically aligned with respect to the substrate surface while no voltage is applied.

3. A liquid crystal display device, as set forth in claim 1, wherein the tilting orientation of the liquid crystal molecules has two or more directions in each domain when projected on the substrate.

4. A liquid crystal display device, as set forth in claim 1, wherein the two substrates comprise electrodes on the opposing surfaces thereof, and wherein the structure is provided on the electrode and is made of dielectric material.

5. A liquid crystal display device, as set forth in claim 1, wherein the structure has a grid-like shape.

6. A liquid crystal display device, as set forth in claim 1, further comprising: first and second polarizing elements provided on the sides of the two substrates, respectively, the sides being not opposed to each other but facing in the opposite directions, and whose axes of absorption are orthogonal to each other; and at least one phase difference film provided at least either between the first polarizing element and the substrate to which the first polarizing element faces or between the second polarizing element and the other substrate, to which the second polarizing element faces.

7. A liquid crystal display device comprising: a first liquid crystal layer in which the liquid crystal molecules have negative dielectric constant anisotropy and are almost vertically aligned with respect to a display surface while no voltage is being applied and aligned in a first orientation while a voltage is being applied when the liquid crystal molecules are projected on the display surface; a second liquid crystal layer in which the liquid crystal molecules have negative dielectric constant anisotropy and are almost vertically aligned with respect to the display surface while no voltage is being applied and aligned in an orientation in the opposite direction to that of the first orientation while a voltage is being applied when the liquid crystal molecules are projected on the display surface; and a first and second polarizing elements provided on the sides of the first and second liquid crystal layers, respectively, the sides being not opposed to each other but facing in opposite directions.

8. A liquid crystal display device, as set forth in claim 7, wherein the first and second liquid crystal layers are each liquid crystal panels.

9. A liquid crystal display device, as set forth in claim 8, wherein the liquid crystal molecules are aligned in multiple orientations including the first and second orientations while a voltage is being applied when projected on the display surface in the first and second liquid crystal layers, and wherein the first and second liquid crystal layers are arranged in such a way that a domain in which the liquid crystal molecules are aligned in the first orientation in the first liquid crystal layer overlaps with a domain in which the liquid crystal molecules are aligned in the second orientation in the second liquid crystal layer, and a domain in which the liquid crystal molecules are aligned in the second orientation in the first liquid crystal layer overlaps with a domain in which the liquid crystal molecules are aligned in the first orientation in the second liquid crystal layer.

10. A liquid crystal display device, as set forth in claim 9, wherein the first and second liquid crystal panels have a alignment control means provided on the electrode, made of dielectric material and for controlling the alignment of the liquid crystal molecules while a voltage is being applied, and wherein the alignment control means of the first liquid crystal panel and the alignment control means of the second liquid crystal panel are symmetric with respect to a middle plane between the first and second liquid crystal panels.

11. A liquid crystal display device comprising: two substrates having an electrode on the opposing surfaces, respectively; a liquid crystal layer in which liquid crystal is enclosed between the two substrates; and alignment control means provided on the electrodes of the first and second substrates, made of dielectric material and for controlling the alignment of the liquid crystal molecules while a voltage is being applied, wherein the liquid crystal molecules have negative dielectric constant anisotropy and are almost vertically aligned with respect to the substrate surface while no voltage is being applied, wherein the alignment control means controls so that first and second domains, in which the tilting orientations of the liquid crystal molecules are different from each other by about 180 degrees when projected on the substrate while a voltage is being applied, are produced within each pixel, and wherein the pitch with which the first and second domains are arranged alternately is equal to or less than ten times the thickness of the liquid crystal layer.

12. A liquid crystal display device, as set forth in claim 11, wherein the width of the boundary domain of the first and second domains is equal to or less than the thickness of the liquid crystal layer.

13. A liquid crystal display device, as set forth in claim 11, wherein the alignment control means controls so that a domain, in which the tilting orientation of the liquid crystal molecules is different from those in the first and second domains when projected on the substrate surface while a voltage is being applied, is produced within each pixel.

14. A liquid crystal display device, as set forth in claim 11, further comprising: a first and second polarizing elements provided on the sides of the two substrates, respectively, the sides being not opposed to each other but facing in opposite directions, and whose axes of absorption are orthogonal to each other; and at least one phase difference film provided at least either between the first polarizing element and the substrate on which the first polarizing element is provided or between the second polarizing element and the other substrate on which the second polarizing element is provided.

15. A liquid crystal display device comprising: two substrates having an electrode on the opposing surfaces, respectively; a liquid crystal layer in which liquid crystal is enclosed between the two substrates; and alignment control means provided on the electrodes of the first and second substrates, made of dielectric material and for controlling the alignment of the liquid crystal molecules while a voltage is being applied, wherein the liquid crystal molecules have negative dielectric constant anisotropy and are almost vertically aligned with respect to the substrate surface while no voltage is being applied, wherein the alignment control means controls so that a first and second domains, in which the tilting orientations of the liquid crystal molecules are different from each other by about 180 degrees when projected on the substrate while a voltage is being applied, are produced within each pixel, and that the first and second domains are shifted in the direction perpendicular to the substrate.

16. A liquid crystal display device, as set forth in claim 15, wherein the alignment control means controls so that the neighboring first and second domains are shifted in the direction perpendicular to the substrate.

17. A liquid crystal display device, as set forth in claim 16, wherein the alignment control means comprises a first step-structure provided in the first domain on the electrode of the second substrate and a second step-structure provided in the second domain on the electrode of the first substrate.

18. A liquid crystal display device, as set forth in claim 15, wherein the alignment control means controls so that the pair of the neighboring first and second domains are divided so as to form a middle domain and that the neighboring middle domains are shifted in the direction perpendicular to the substrate.

19. A liquid crystal display device, as set forth in claim 18, wherein the alignment control means divides the neighboring middle domains into a first middle domain and a second middle domain alternately and has a first step-structure provided in the first middle domain on the electrode of the second substrate and a second step-structure provided in the second middle domain on the electrode of the first substrate.

20. A liquid crystal display device, as set forth in claims 17 or 19, wherein the first step-structure and the second step-structure control the thickness of the liquid crystal layer.
